(19) United States
(12) Patent Application Publication
(10) Pub. No.: US 2008/0010374 A1
(43) Pub. Date: Jan. 10, 2008

(54) Control point device in UPNP network and method of registering preference device thereof

(75) Inventors: Jong-sub Lim, Seoul (KR); Jun-hyung Ha, Seoul (KR); Jun-seung Lee, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/708,016

(22) Filed: Feb. 20, 2007

(30) Foreign Application Priority Data
Jul. 10, 2006 (KR) 2006-64162

(51) Int. Cl. G06F 15/173

(52) U.S. Cl. 709/225

(57) ABSTRACT

A control point in a UPnP network and a method of registering a preference device thereof eliminate discovery and description operations with respect to a preference in the UPnP network. The control point includes a preference device registration unit to register a device selected among a plurality of devices connected to the network as a preference device, a storage unit to store information on pre-registered preference devices and information on services provided by the preference devices, and a UPnP processing unit to receive and process the corresponding service by using information on the preference device selected among the stored preference devices and the information on the service provided by the preference device if one of the stored preference devices is selected.

### CROSS-REFERENCE TO RELATED APPLICATIONS

This application claims priority under 35 U.S.C. §119 of Korean Patent Application No. 10-2006-0064162, filed Jul. 10, 2006, in the Korean Intellectual Property Office, the entire disclosure of which is incorporated herein by reference.

### BACKGROUND OF THE INVENTION

1. Field of the Invention

The general inventive concept relates to a control point device in a universal plug and play (UPnP) network and a method of registering a preference device of the UPnP network. More particularly, the general inventive concept relates to a control point device in a UPnP network and a method of registering a preference device connected to the UPnP network, which can eliminate discovery and description operations to use a service provided from the preference device in the UPnP network.

2. Description of the Related Art

A home network is a home system, expected to be common in the future, that can operate home devices, such as a PC, a TV receiver, a refrigerator, an air conditioner, and so forth, through a wireless device such as a portable phone by connecting the home devices and spaces in the home through a network and transferring information through the network.

Generally, a home network is composed of an Internet Protocol (IP)-based private network, and connects all kinds of home devices used, at home, through a network to control the home devices.

As a service discovery protocol (SDP) to facilitate communications among several home devices in a home network, middleware such as Universal Plug and Play (UPnP), Home AV Interoperability (HAVI), Jini, and Home Wide Web (HWW) has been proposed.

Among them, the UPnP system will be described in detail. Through the UPnP and/or other middleware, home devices can dynamically join the network, secure IP (internet protocol) addresses, transfer functions, and confirm the existence and function of other home devices. In addition, the home devices can continuously and directly communicate with other home devices to strengthen peer to peer networking functions.

A network system using, for example, UPnP is composed of a plurality of devices. A device that requests a service to another device among the plurality of devices is called a control point (CP).

FIG. 1 is a flowchart explaining an operation of a conventional UPnP network system.

In the UPnP network system, in order to use a service provided from another device, the control point passes through an addressing step S10, a discovery step S11, a description step S12, a control step S13, an eventing step S14, and a presentation step S15.

Among the above-described steps, the control point can recognize a usable device through the discovery step S11, and can recognize a service provided by that device through the description step S12.

That is, in the conventional UPnP network system, the control point can use the service provided by the device only by obtaining a URL (e.g., uniform resource locator or internet address) having information on the device through the discovery operations S11, and then bring the device information and service information through the corresponding URL at the description operation S12.

As described above, in the UPnP network system, it is necessary to pass through the discovery operation S11 and the description operation S12. Accordingly, even in the case of a frequently used device, it is necessary to pass through the discovery operation S11 and the description operation S12 each time that the device information and the service information are required.

In addition, an excessive time may be required to perform the discovery step S11 according to the network conditions, and according to circumstances, the discovery step S11 may not be performed.

The discovery operation S11 may be divided into a control point's search step of searching the device, and a device's advertisement step of informing the control point of its own existence.

In this case, if the control point searches the devices by sending a multicast message in the search step, the device having received the message should respond to this within a predetermined time, but the search time may be delayed due to the traffic on the network. Also, even in the advertisement step, the control point may not receive the device's message due to the traffic on the network.

Also, in the discovery operation S11, information on all the devices existing on the network is transmitted irrespective of a user's actual request, and this causes a user inconvenience.

### SUMMARY OF THE INVENTION

The general inventive concept includes providing a control point in a UPnP network and a method of registering a preference device connected to the network, which makes it possible to use a service provided from a frequently used device in a UPnP network more promptly, by eliminating discovery and description steps.

Additional aspects and advantages of the present general inventive concept will be set forth in part in the description which follows and, in part, will be obvious from the description, or may be learned by practice of the general inventive concept.

The foregoing and other objects and aspects, may be achieved by providing a control point in a Universal Plug and Play (UPnP) network, which includes a preference device registration unit to register a device selected from among a plurality of devices connected to a network as a preference device, a storage unit to store information on pre-registered preference devices and information on services provided by the preference devices, and a UPnP processing unit to receive and process the corresponding service by using information on the preference device selected from among the stored preference devices and the information on the service provided by the selected preference device.

The control point may further include a user interface unit to output a list of the registered preference devices.

The UPnP processing unit may include a discovery unit to search for the device connected to the network, an information collection unit to collect the information on the searched device and the information on the service provided by the device, and a control unit to process the service provided from the device by using the information on the searched device and the information on the service provided by the device.

The UPnP processing unit may further include a device state confirming unit to seize a usable state of the preference device by using the information on the selected preference device.

The UPnP processing unit may further include a user interface unit to classify the preference devices according to their usable states seized by the device state confirming unit and to output the preference device list accordingly.

The preference device registration unit, if a state change report signal is received from the pre-registered preference device, may receive the information on the preference device having transmitted the state change report signal and the information on the service provided by the preference device through the UPnP processing unit, and update the storage unit accordingly. The preference device registration unit may update the information on the preference device and the information on the service provided by the preference device in real time.

The foregoing and other aspects of the present general inventive concept may also be achieved by providing a method of registering a preference device of a control point, the method including registering a device selected from among devices connected to a network as a preference device, to store information on pre-registered preference devices and information on services provided by the preference devices, and, if one of the stored preference devices is selected, to receive and process the corresponding service by using information on the selected preference device and the information on the service provided by the preference device.

The method may further include registering the device selected from among the devices connected to the network as the preference device.

The method may further include outputting a list of the pre-registered preference devices.

The method may further include seizing a usable state of the preference device by use of the information on the selected preference device.

The method may further include classifying the preference devices according to their seized usable states and to output the list of the preference devices accordingly to the classification.

If a state change report signal is received from a pre-registered preference device, the information on the preference device that transmitted the state change report signal and the information on the service provided by the preference device may be received, and the stored information on the preference device and the information on the service provided by the preference device may then be updated. The update of the information on the preference device and the information on the service provided by the preference device may be performed in real time.

The present general inventive concept includes a control point to receive a service from another device in a network, the control point device including a processing unit to determine whether a device is a pre-registered preference device, and to control the device to perform a service using pre-stored information on the pre-registered preference device and the service, upon a determination of whether the device is in the pre-registered preference device.

The present general inventive concept includes a control point device to receive a service from another device in a network, the control point device including: a storage unit to store information on a pre-registration preference device and a service provided by the pre-registered preference device; and a processing unit to control a device to perform the service using the stored information when the device is the pre-registered preference device and to obtain another information on the device and another service of the device to control the device to perform the another service when the device is not the pre-registered preference device.

The present general inventive concept includes a method of a control point device to receive a service from another device in a network, the method comprising: determining whether is a pre-registered preference device, and controlling the device to perform a service using pre-stored information on the device and the service upon a determination of whether the device is the registered preference device.

The present general inventive concept includes a method of a control point device to receive a service from another device in a network, the method comprising: storing information on a pre-registered preference device and a service provided by the pre-registered preference device; and controlling a device to perform the service using the stored information when the device is the pre-registered preference device, and to obtain another information on the device and another service of the device to control the device to perform the another service when the device is not the pre-registered preference device.

The present general inventive concept includes a computer readable recording medium containing computer readable codes as a program to perform a method of a control point device to receive a service from another device in a network, the method comprising: determining whether is a pre-registered preference device; and controlling the device to perform a service using pre-stored information on the device and the service upon a determination of whether the device is the registered preference device.

The present general inventive concept includes a computer readable recording medium containing data executable as a software program to instruct the computer to perform a method, the method comprising: storing information on a pre-registered preference device and a service provided by the pre-registered preference device; and controlling a device to perform the service using the stored information when the device is the pre-registered preference device, and to obtain another information on the device and another service of the device to control the device to perform the another service when the device is not the pre-registered preference device.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart explaining an operation of a conventional UPnP network system;

FIG. 2 is a block diagram illustrating a UPnP network system according to an embodiment of the present general inventive concept;

FIG. 3 is a view illustrating a discovery operation in a UPnP network system illustrated in FIG. 2;

FIG. 4 is a view illustrating an information collection operation in the UPnP network system illustrated in FIG. 2;

FIG. 5 is a flowchart illustrating a method of registering a preference device according to an embodiment of the present general inventive concept;

FIG. 6 is a flowchart illustrating a method of using a service provided by a preference device according to an embodiment of the general inventive concept; and

FIG. 7 is a flowchart illustrated a general method of the general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

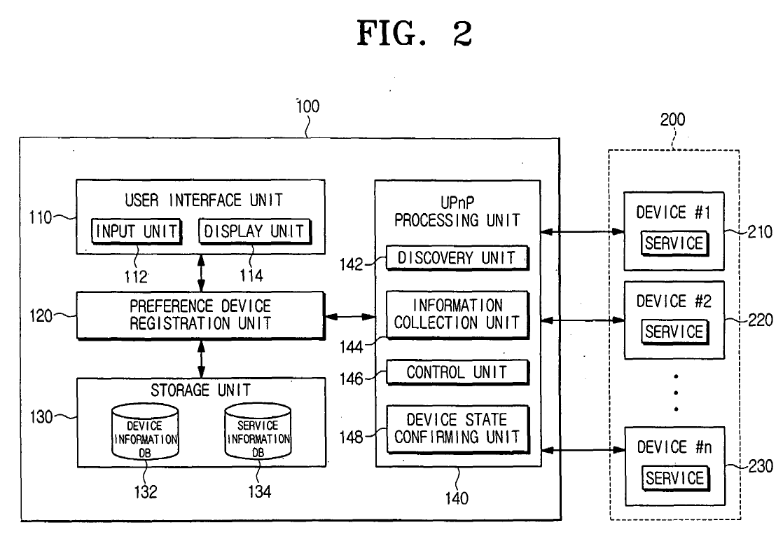

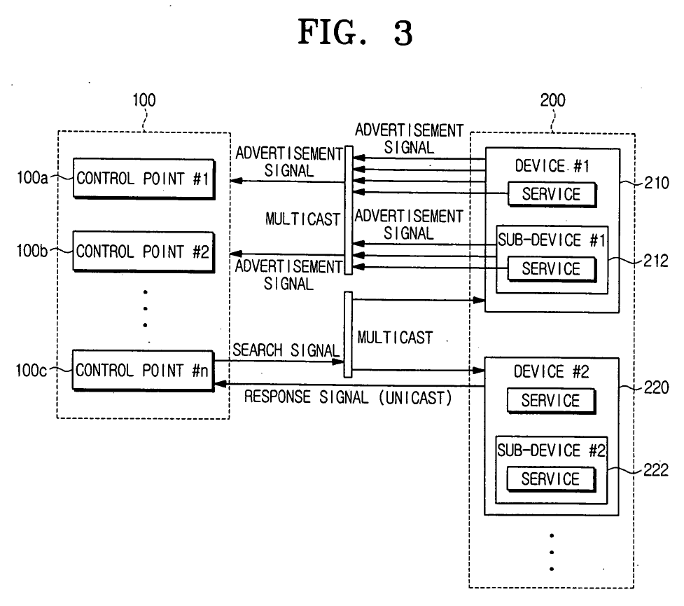

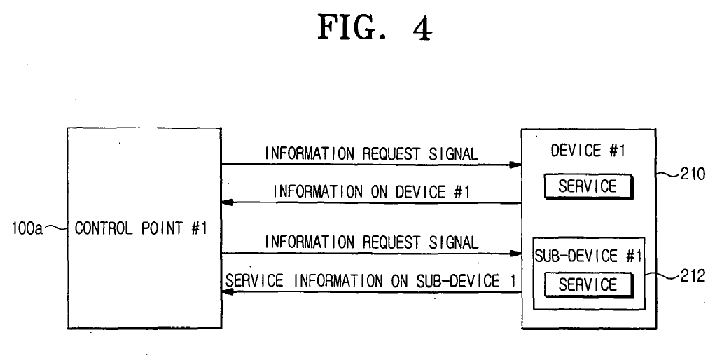

FIG. 2 is a block diagram illustrating a Universal Plug and Play (UPnP) network system according to an embodiment of the present general inventive concept. FIG. 3 is a view illustrating a discovery operation (mode) in the UPnP network system illustrated in FIG. 2, and FIG. 4 is a view illustrating an information collection operation (mode) in the UPnP network system illustrated in FIG. 2.

Referring to FIG. 2, the UPnP network system includes a plurality of UPnP devices 100 and 200. The UPnP devices 100 and 200 may include a device connectable to a UPnP network, and may include one of various digital devices such as a digital TV, a mobile phone, a remote control device, and so forth. Among the UPnP devices 100 and 200, any one of the devices that requests a service to another device is called a control point or a control point device 100.

In the embodiment of FIG. 2, the UPnP network system includes a control point 100, and devices labeled as 210 to 230 referring to device #1 to device #n, where n indicates any positive integer. However, depending on which of the devices requests and provides a service, any one of device #1 to device #n, labeled 210 to 230, may serve as the control point 100, and in this case, the control point 100 operates in the same manner as other devices that provide services.

The control point 100 includes a user interface unit 110, a preference device registration unit 120, a storage unit 130, and a UPnP processing unit 140.

The user interface unit 110 supports an interface between a user and the control point 100. The embodiment of FIG. 2 exemplifies that the user interface unit 110 may include an input unit 112 and a display unit 114 having an input function and a display function respectively. However, the user interface unit 110 may be implemented in the form of a touch screen having both the input and display functions.

The input unit 112 receives a specified input signal through a user's manipulation. A selection signal to select a device intended to be registered as a preference device from among devices #1 to #n, 210 to 230, and a selection signal to select a preference device from the preference device list, or a selection signal to select a service provided by the preference device, are inputted through the input unit 112.

The display unit 114 displays specified information to be provided to the user under the control of the preference device registration unit 120. A list of devices #1 to #n connected to the UPnP network, and a list of preference devices registered in the storage unit 130, and a list of services provided by the preference devices, are displayed.

The preference device registration unit 120 registers a device selected by the user among devices #1 to #n, 210 to 230, as a preference device. That is, if devices #1 to #n, 210 to 230, connected to the UPnP network are searched through the UPnP processing unit 140, the preference device registration unit 120 makes the display unit 114 display a list of the searched devices 210 to 230, and the user selects a device from the list which is registered as the preference device.

After registering the preference device according to the user's selection, the preference device registration unit 120 stores information on the registered preference device and information on the service provided by the registered preference device in the storage unit 130.

The preference device information may include a device name, a manufacturer name, and a serial number. Also, the service information may include a printing state and the number of prints, if the corresponding preference device is a printer.

When the control point 100 starts its operation, the preference device registration unit 120 outputs a list of the pre-registered preference devices to the display unit 114. The list of the pre-registered preference devices may include the above-described registered preference device. If a user selects a specified preference device from the list of the preference devices being displayed on the display unit 114, the preference device registration unit 120 extracts information on the selected preference device and information on the service provided by the preference device from the storage unit 130.

After extracting the information on the selected preference device and the information on the service provided by the preference device from the storage unit 130, the preference device registration unit 120 controls the UPnP processing unit 140 to receive the corresponding service.

If a state change report signal is received from a corresponding pre-registered preference device, the preference device registration unit 120 receives information on the preference device having transmitted the state change report signal and information on the service provided by the preference device through the UPnP processing unit 140, and updates the storage unit 130 accordingly. In this case, the state change report signal from the pre-registered preference device may be a “Notify event” signal transmitted to the control point 100 whenever the state of the preference device is changed. The update of the information on the preference device and the information on the service provided by the preference device may be performed in real time.

The storage unit 130 stores the information on the preference devices registered by the preference device registration unit 120 and the information on the service provided by the preference devices. For this purpose, the storage unit 130 comprises a device information database 132 and a service information database 134.

The device information database 132 stores the information on the preference devices registered by the preference device registration unit 120. Accordingly, the device information database 132 stores information such as a device name, a manufacturer name, and a serial number for each preference device that is selected.

The service information database 134 stores the information on the services provided by the preference devices registered by the preference device registration unit 120. For example, if the corresponding preference device is a printer, the service information database 134 stores a print state, the number of prints, and so forth. This is done for each preference device.

If the preference device registration unit 120 extracts the information on the pre-registered preference device and the information on the service provided by the preference device from the storage unit 130, the UPnP processing unit 140 receives and processes the corresponding service by using the extracted preference device information on the service information.

The UPnP processing unit 140 comprises a discovery unit 142, an information collection unit 144, a control unit 146, and a device state confirming unit 148.

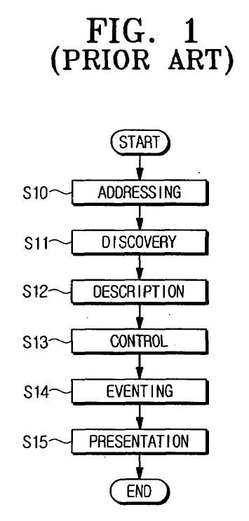

The discovery unit 142 may perform the discovery operation S11 as described above with reference to FIG. 1, which may be the same as that in the conventional UPnP device. Referring to FIG. 3, the function of the discovery unit 142 will be briefly described.

As illustrated in FIG. 3, the UPnP network system may include control points #1 to #n, labeled in FIG. 3 as 100a to 100c, and device #1 and device #2, labeled as 210 and 220, for example.

Here, device #1, 210, or device #2, 220, may be a multifunctional device in which several devices are combined, and the respective devices in the multifunctional device may be UPnP devices providing respective services. For example, if device #1 is a multifunctional device, sub-device #1, 212, may be a printer or a scanner.

A discovery method performed by the discovery unit 142, for example, may be a method of transmitting a multicast transmission type advertisement signal from the device 200 to the control point 100.

Device #1, 210, and device #2, 220, of the UPnP network, transmit advertisement signals for informing control point #1, 100a, to control point #n, 100c, of their existence through multicast messages.

By receiving the advertisement signals transmitted from device #1, 210, and device #2, 220, the discovery unit 142 can recognize that device #1, 210, and device #2, 220, are connected to the UPnP network.

Another discovery method performed by the discovery unit 142 may be a method of transmitting a multicast transmission type search signal from the control point 100 to the device 200.

The control point #n, 100c, which presently exists in the UPnP network, transmits a search signal to request a response to device #1, 210, and device #2, 220, through a multicast message.

Device #1, 210, and device #2, 220, which have received the search signal from the control point #n, 100c, transmit unicast transmission type response signals to the control point #n. By the response signals transmitted from device #1, 210, and device #2, 220, the control point #n, 100c, can recognize that device #1, 210, and device #2, 220, are connected to the UPnP network.

The information collection unit 144 may perform the description operation S12 as described above with reference to FIG. 1, which is the same as that in the conventional UPnP device. Referring to FIG. 4, the function of the information collection unit 144 will be briefly described.

The drawing exemplifies that control point #1, 100a, among control points #1 to #n, 100a to 100c, intends to use the service provided by device #1, 210.

In the case where control point #1, 100a, intends to use the service provided by sub-device #1, 212, in device #1, 210, it transmits an information request signal to device #1, 210. Device #1, 210, having received the information request signal, transmits its own information to control point #1, 100a. In this case, information concerning device #1, 210, includes information of sub-device #1, 212.

Thereafter, the control point #1, 100a, transmits the information request signal to sub-device #1, 212. Sub-device #1, 212, having received the information request signal from the control point #1, 100a, transmits the information on the service that the sub-device holds to control point #1, 100a.

As described above, the control point #1, 100a, receives the information on the desired service by transmitting the information request signal to device #1, 210, or sub-device #1, 212, from which the control point intends to receive the service.

The functions of the discovery unit 142 and the information collection unit 144 as illustrated in FIGS. 3 and 4 are selectively performed only in the case where other devices, except for the pre-registered preference devices, should be used. When using the pre-registered preference device, these functions are not performed.

The control unit 146 processes the service provided by the device by using information collected by the discovery unit 142 and the information collection unit 144 and the service information provided by the device.

When the preference device information and the service information provided by the preference device are extracted from the storage unit 130 by the preference device registration unit 120, even if the discovery unit 142 and the information collection unit 144 do not operate, the control unit 146 receives and processes the corresponding service from the preference device by using the extracted preference device information and the service information provided by the preference device.

The device state confirming unit 148 seizes the usable state of the preference device (for example, the availability of the preference device) by using the preference device information extracted by the preference device registration unit 120. The seizing of the usable state of the preference device in the device state confirming unit 148 may be performed using ping. (A “ping” is a network tool used to ascertain whether or not a device is reachable across an IP network. It is named in analogy to the sonar “ping” sound and is also known as an “echo request.”)

As the device state confirming unit 148 seizes the usable state of the preference device extracted by the preference device registration unit 120 and provides the seized usable state to the user, the user can select one preference device that will provide the service among the presently usable (or, available) preference devices.

In the case of seizing the usable state of the preference device through the device state confirming unit 148, a preference list to classify the preference devices according to the usable state of the seized preference device is outputted to the display unit 114.

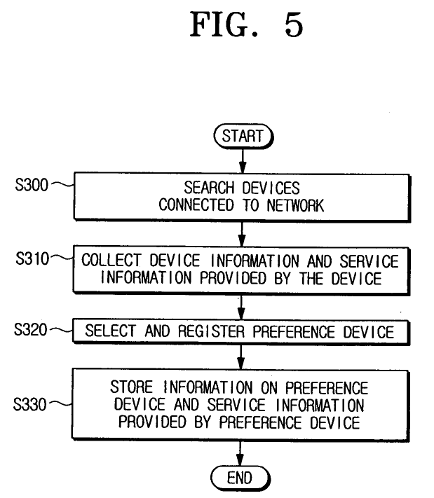

FIG. 5 is a flowchart illustrating a method of registering a preference device according to an embodiment of the present general inventive concept. Referring to FIGS. 1 to 5, the method of registering a preference device according to exemplary embodiments of the present invention will be described.

The discovery unit 142, as described above with reference to FIG. 3, searches the devices connected to the UPnP network through either an advertisement signal reception or a search signal transmission at operation S300.

After the device search made by the discovery unit 142, the information collection unit 144, as described above with reference to FIG. 4, collects the information on the services provided by the device searched by the discovery unit 142 in accordance with the method of transmitting the information request signal to a desired device at operation S310.

If the devices connected to the UPnP network are searched by the discovery unit 142 and the device information and the service information provided by the devices are collected by the information collection unit 144, the device list is outputted through the display unit 114. If a user selects a device to be registered as the preference device from the outputted list, the preference device registration unit 120 registers the selected device as the preference device at operation S320.

After the registration of the preference device, the preference device registration unit 120 stores the registered preference device information and the service information thereof in the storage device 130. In this case, the preference device information is stored in the device information database 132, and the service information is stored in the service information database 134 at step S330.

Through the above-described process, the information on the registered preference device and the information on the service provided by the preference device are stored in the storage unit 130, and thus it is not required to perform the discovery step S11c and the description step S12 with respect to the registered preference.

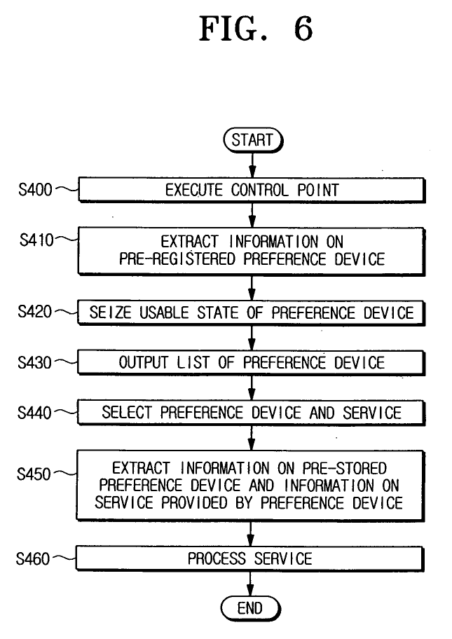

FIG. 6 is a flowchart illustrating a method of using a service provided by a preference device according to an embodiment of the present general inventive concept. Hereinafter, the method of using a service provided by a preference device will be described with reference to FIGS. 1 to 6.

Here, it is assumed that the control point 100 has performed the method of registering a preference device as illustrated in FIG. 5, and a device having been registered as the preference device by the preference device registration unit 120 exists at step S410.

After extracting the preference device information, the preference device registration unit 120 provides the extracted preference device information to the UPnP processing unit 140 so as to seize the usable state of the preference device. In this case, the device state confirming unit 148 seizes the usable state of the preference device by using ping at step S420.

By the information on the usable state of the preference device seized through the device state confirming unit 148, the preference device registration unit 120 controls the display unit 114 to output a list of the preference devices classified according to the usable states of the preference devices. In this case, it is preferable to output a list of services provided by the preference devices together with the list of the preference devices, for the user's convenience, at step 430.

Through the list displayed on the display unit 114, the user selects a desired preference device or a desired service. A user's selection signal inputted through the input unit 112 is inputted to the preference device registration unit 120 at operation S440.

The preference device registration unit 120 extracts the preference device information corresponding to the user's selection signal and the information on the service provided by the preference device from the storage unit 130 at operation S450.

The preference device registration unit 120 provides the extracted preference device information and the service information to the UPnP processing unit 140. The control unit 146 of the UPnP processing unit 146 receives and processes the service from the corresponding preference device by using the preference signal information extracted from the registration unit 120 and the service information provided by the preference device at operation S460.

If the control point 100 intends to use a service of another device that has not been registered in the preference device registration unit 120, it should perform the preference device registration method as illustrated in FIG. 5.

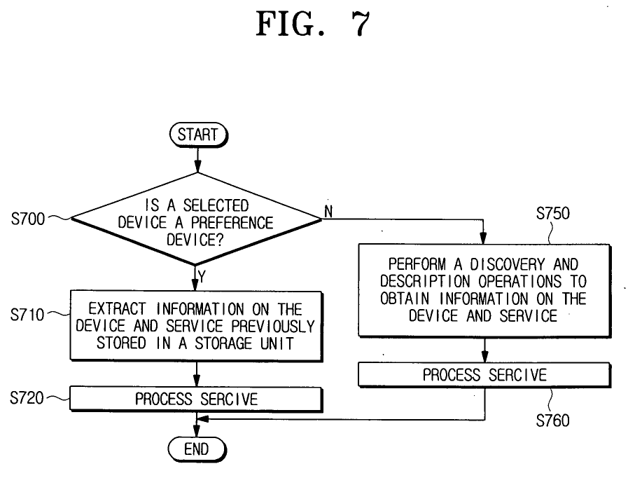

FIG. 7 is a view illustrating a method of obtaining information on a device and a service a processing the service according to an embodiment of the present general inventive concept. The method includes determining whether the selected device is a preference device (at S700). If it is, then information on the device and the service which it performs is extracted from a storage unit such as storage unit 130 in FIG. 2 (at S710) and then, that service is processed (S720)/ Of the selected device is not a preference device, then discovery and description operations such as S10 and S11 in FIG. 1 are performed, and the service which the device performs is processed.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

As described above, a device selected among the searched devices is registered as the preference device, and the discovery and description steps can be eliminated, so that the service provided by a frequently used device on the UPnP network can be reached more promptly.

In addition, discovery failures and delays caused by the condition of the network can be prevented, and the network load due to the discovery step can be reduced. In particular, by registering the frequently used devices as the preference devices, the user can simply use only the necessary devices.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A control point device to receive a service from another device connected to a network, the control point device comprising:
a preference device registration unit to register at least one of external devices as a preference device;
a storage unit to store information on one or more pre-registered preference devices including the registered device and information on one or more services provided by the pre-registered preference devices; and
a universal plug and play (UPnP) processing unit to receive and process the information on one of the pre-registered preference devices and the information on the service provided by the one of the registered preference when the one of the stored pre-registered preference devices is selected.

2. The control point of claim 1, further comprising a user interface unit to output a list of the pre-registered preference devices.

3. The control point of claim 1, wherein the UPnP processing unit comprises:
a discovery unit to search for another one of the devices connected to the network;
an information collection unit to collect information on the searched device and information on a service provided by the searched device; and
a control unit to process the service provided from the searched device by using the information on the searched device and the information on the service provided by the searched device.

4. The control point of claim 1, wherein the UPnP processing unit comprises a device state confirming unit to seize a usable state of the preference device by using the information on the preference device.

5. The control unit of claim 4, further comprising:
a user interface unit to classify the preference devices according to the usable state seized by the device state confirming unit and to output the preference device list.

6. The control unit of claim 1, wherein, if a state change report signal is received from the pre-registered preference device, the preference device registration unit receives the information on the preference device that have transmitted the state change report signal and the information on the service provided by the preference device through the UPnP processing unit, and updates the storage unit.

7. The control unit of claim 1, wherein the preference device registration unit updates the information on the preference device and the information on the service provided by the preference device in real time.

8. A method of registering a preference device of a control point, the method comprising:
registering at least one of external devices connected to a network as a preference device;
storing information on one or more pre-registered preference devices including the preference device and information on services provided by the pre-registered preference devices; and
if one of the stored pre-registered preference devices is selected, receiving and processing information on the selected preference device and the information on a service provided by the selected pre-registered preference device.

9. The method of claim 8, further comprising:
registering the device selected among the devices connected to the network as the preference device in a list of pre-registered preference devices.

10. The method of claim 8, further comprising:
outputting a list of the pre-registered preference devices.

11. The method of claim 8, further comprising:
seizing a usable state of the preference device according to the information on the selected preference device.

12. The method of claim 11, further comprising:
classifying the preference devices according to their seized usable states and outputting the list of the preference devices.

13. The method of claim 8, wherein if a state change report signal is received from the pre-registered preference device, the information on the preference device that has transmitted the state change report signal and the information on the service provided by the preference device that transmitted the state change report signal is received, and the stored information on the preference device that has transmitted the state change report signal and the information on the service provided by the preference device that has transmitted the state change report signal are updated.

14. The method of claim 13, wherein the updating of the information on the preference device and the information on the service provided by the preference device comprises updating the information in real time.

15. A control point to receive a service from another device in a network, the control point device comprising:
a processing unit to determine whether a device is a pre-registered preference device, and to control the device to perform a service using pre-stored information on the pre-registered preference device and the service, upon a determination of whether the device is in the pre-registered preference device.

16. The control point according to claim 15, further comprising:
a storage unit to store the pre-stored information including first information on the pre-registered preference device and second information on the service provided by the pre-registered preference device.

17. The control point according to claim 15:
wherein the processing unit does not communicate with the device to obtain the pre-stored information according to the determination

18. The control point according to claim 15:
wherein the processing unit does not perform discovery and collection operations to obtain the pre-stored information according to the determination.

19. The control point according to claim 15, further comprising:
an interface unit to communicate with the device to update the pre-stored information.

20. The control point according to claim 15, further comprising:
an interface unit to generate an image signal to display on image representing the pre-stored information

21. A control point device to receive a service from another device in a network, the control point device comprising:
a storage unit to store information on a pre-registration preference device and a service provided by the pre-registered preference device; and
a processing unit to control a device to perform the service using the stored information when the device is the pre-registered preference device and to obtain another information on the device and another service of the device to control the device to perform the another service when the device is not the pre-registered preference device.

22. A method of a control point device to receive a service from another device in a network, the method comprising:
determining whether is a pre-registered preference device; and
controlling the device to perform a service using pre-stored information on the device and the service upon a determination of whether the device is the registered preference device.

23. A method of a control point device to receive a service from another device in a network, the method comprising:
storing information on a pre-registered preference device and a service provided by the pre-registered preference device; and
controlling a device to perform the service using the stored information when the device is the pre-registered preference device, and to obtain another information on the device and another service of the device to control the device to perform the another service when the device is not the pre-registered preference device.

24. A computer readable recording medium containing computer readable codes as a program to perform a method of a control point device to receive a service from another device in a network, the method comprising:
determining whether is a pre-registered preference device; and
controlling the device to perform a service using pre-stored information on the device and the service upon a determination of whether the device is the registered preference device.

25. A computer readable recording medium containing data executable as a software program to instruct the computer to perform a method, the method comprising:
storing information on a pre-registered preference device and a service provided by the pre-registered preference device; and
controlling a device to perform the service using the stored information when the device is the pre-registered preference device, and to obtain another information on the device and another service of the device to control the device to perform the another service when the device is not the pre-registered preference device.
